(19) United States
(12) Patent Application Publication
(10) Pub. No.: US 2025/0033504 A1
(43) Pub. Date: Jan. 30, 2025

(54) Magnetic Robot Charging Station and Method

(71) Applicant: Quasi Inc, Ijamsville, MD (US)

(72) Inventors: Vladimir Lebedev, Ijamsville, MD (US); Fedor Bokov, Rockville, MD (US); Maxim Didenko, Poolesville, MD (US)

(21) Appl. No.: 18/359,579

(22) Filed: Jul. 26, 2023

(51) Int. Cl. B60L 53/36; B60L 53/12; B60L 53/38; B60L 53/65; G05D 1/02; H02J 7/00

(52) U.S. Cl. CPC B60L 53/36; B60L 53/12; B60L 53/38; B60L 53/65; H02J 7/0042; B60L 2240/54

(57) ABSTRACT

A magnetic charging station and method of use is disclosed herein. The magnetic charging station is adapted to receive a robot and connect to the robot to charge a power source on the robot. The magnetic charging station is designed to improve the consistency and safety of charging by offering multiple mechanism to ensure proper alignment of the charging contacts. Having a tread receptacle that begins wide and narrows towards the end makes it easy for a robot entering the station to reach the correct position, and magnets assist in aligning and holding the robot to a charging contact. The charging contact on the charging station may be biased with a spring, allowing the charging contact to smoothly connect to a charging point on the robot. A method of use is further disclosed to describe the process of monitoring battery levels, managing multiple charging station in a network, and issuing instructions to the components of the system using a cloud connect software system.

### FIELD OF THE INVENTION

The present invention relates generally to electronics and electronic charging devices. Specifically, the present invention is a charging station having magnetic connection points designed to charge autonomous robots.

### BACKGROUND OF THE INVENTION

With the advent of autonomous robotics and improved AI systems, robots and robotic apparatuses are more frequently found roaming areas to complete tasks. It is often desirable that such robots can return to a charging point autonomously, without the need for manual intervention by the user. However, such a process can be prone to error, and can often result in loose connections, slow charging, or other hazards. There thus exists a need for an improved charging station and method of charging autonomous or remotely-operated robots.

To that end, the present invention is a magnetic robot charging station and method. The charging station may comprise a power supply, an electrical circuit, a voltage board, a stage-based relay, a wireless connector, a modular contact plate, a tread receiver, a rear access panel, a fan, a power outlet, an indicate light, a plurality of ventilation holes, and a modular charging mechanism. The modular charging mechanism may comprise a charging housing, a contact charging plate, a rare earth magnet, a plate spring, and a central metal plate.

In an ideal embodiment, the charging station connects to one or more robots using the wireless connector. The charging station may then communicate directly with the robots, or the communication may be managed by a cloud connect system, such as a cloud-implemented software managed remotely. The cloud connect system can keep track of the status of multiple charging stations, indicating whether they are available, if they are turned on, and if there are any errors with the charging stations. Furthermore, the cloud connect system can provide an environmental map of the area to the robot, allowing the robot to easily navigate to the charging stations. If a robot has low battery, the cloud connect software may instruct the robot to enter a low power mode to turn off non-essential functions and, using the environmental map of the area, immediately navigate to the nearest open and working charging station.

When a robot approaches the charging station, the robot may first use an onboard camera to visually inspect and identify the charging station. Once the charging station is confirmed, the robot may position itself near the entrance of the charging station—for example, by the tread receiver. The tread receiver is ideally wide at the entrance and narrow at the end, which will naturally guide the robot into the correct position as it moves onto the charging station. As the robot moves onto the tread receiver, it may activate a hall effect sensor to detect the magnet field produce by the magnets that are positioned within the modular charging mechanism. Once the magnetic field is detected, the robot may activate an electromagnet positioned above the central metal plate. This will adjust the robot and fasten it in place properly above the modular charging mechanism, ensuring that the contacts for charging are properly aligned. The modular charging mechanism has contact charging plates adapted to contact charging points on the robot, and has magnets designed to contact metal plates on the robot to further ensure the robot is properly aligned. In the ideal embodiment, the contact charging plate on the charging station sits above a plate spring. The plate spring is adapted to freely bias or allow the contact charging plate to depress as pressure is applied from the weight of the robot. This ensure the contact charging plate can move and adapt to even an uneven surface or a slightly misaligned robot to allow for the best charging, while further allowing the charging points on the robot to press fully against the contact charging plate, enabling the best charging connection. Once in place, the robot or charging station may signal the cloud connect system that the charging station is occupied, and the cloud connect system may instruct the charging station to begin charging.

Once charging, the robot or charging station may monitor the charge level of the robot by measuring the electrical resistance in the circuit. The cloud connect system may determine a required threshold charging level based on a variety of queued tasks. Once the threshold charging level is reached, the cloud connect system can instruct the robot to disconnect from the charging system, and can instruct the charging station to stop charging. At this point, the robot may turn of the electromagnet and leave form the charging station. The cloud connect system may then mark the charging station as empty, and ready to receive another robot.

Referring now to the charging station, during the charging process, the indicator light may change colors based on the charging status—for example, green indicating full charge, red indicating low charge, and yellow indicating a medium level of charge. The charging station may be powered by a direct connection to the power outlet. The fan may be used to cool and ventilate the electrical circuit, voltage board, plurality of relays, and other electronics, which are ideally positioned in the rear access panel. The plurality of ventilation holes ensures the fan can properly move through the rear access panel.

Thus, the present invention is a charging station and method of use that offers management of a multitude of robots while offering improved charging connection to maximize charging speed of any robot or other device that is sought to be charged, avoiding problems with poor connections or other hazards inherent in the state of the art.

### BRIEF DESCRIPTION OF THE DRAWINGS

FIG. 1 shows a top-front-right perspective view of the present invention.

FIG. 2 shows a bottom-back-left perspective view of the present invention.

FIG. 3 shows a top-down view of the present invention.

FIG. 4 shows a cross sectional view of FIG. 3 taken along line A-A.

FIG. 5 shows a cross sectional view of FIG. 3 taken along line B-B.

FIG. 6 shows a perspective view of the modular charging mechanism.

FIG. 7 shows a cross sectional view of FIG. 6 taken along line C-C.

FIG. 8 shows a bottom view of the modular housing mechanism with the housing removed, showing the power terminal connection.

FIG. 9 shows a system diagram of the cloud connect system.

FIG. 10 shows a flowchart of an exemplary embodiment of the method of use.

FIG. 11 shows a system diagram of the electrical circuit.

### DETAIL DESCRIPTIONS OF THE INVENTION

All illustrations of the drawings are for the purpose of describing selected versions of the present invention and are not intended to limit the scope of the present invention. Unless stated otherwise, all references to wireless communication between components should be understood to be performed by methods well-known in the art, such as the transfer of data over wireless connection, between servers, or similar. It should be understood that any reference to “a” component includes the meaning “at least one” component. Thus, a reference to “a” component should be understood to include one or more of the stated component, unless otherwise stated. Unless otherwise specified, it should be understood that any component that is stated to be “positioned on” or “fastened to” another component is connected using any means that is well-known in the art, including but not limited to: screws, bolts, nuts, adhesive, hook-and-loop fastener, or any similar fastening means that is well-known in the art. The phrase “positioned on” should further be understood to encompass the component being integral to the component upon which it is positioned. The phrase “wireless connector” or any similar reference to a wireless connection device should be construed to ideally comprise a device capable of 2.4 Ghz wireless connection protocol, but should be understood to encompass other similar wireless connection protocols or wi-fi enabled connectors. The term “robot” should be read to encompass any device capable of self-propulsion that is well-known in the art, the ideal embodiment specifically referring to a device that is capable of both self-propulsion and self-navigation. The phrase “instructing” a device to perform an action should be understood to mean issuing a digital, wireless, or similar command to execute an action using a processor or similar device well-known in the art.

The present invention is a magnetic charging station 100 (hereinafter “charging station”) and a method of use thereof.

The charging station 100 may comprise a power supply 124, an electrical circuit 102, a voltage control board 104, a power transformer, an electrical terminal, an electrical relay, a wireless connector 120, a modular charging mechanism 122, a tread receiver, a rear access panel 130, a fan 132, a power outlet 134, an indicator light 136, an interior compartment 170, and a plurality of ventilation holes 138.

The modular charging mechanism 122 may further comprise a charging housing 300, a contact charging plate, a rare earth magnet, a plate spring, and a central metal plate 310.

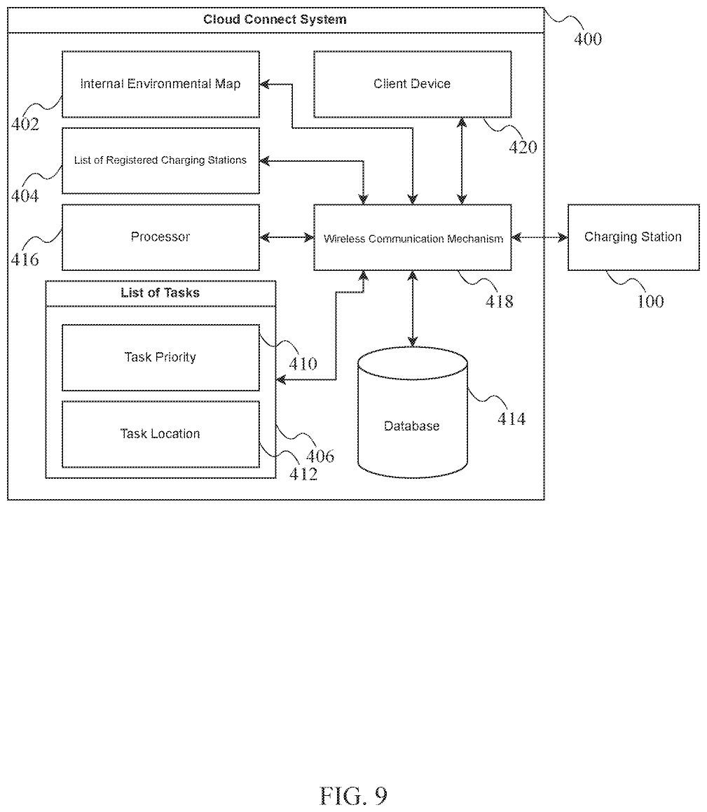

Referring now to FIG. 9, a cloud connect system 400 may be used to manage a charging station 100 and a robot. The cloud connect system 400 may comprise a computer application and necessary hardware as is well-known in the art. In the ideal embodiment, the cloud connect system 400 may comprise a database 414, a wireless communication mechanism 418, and a processor 416. In some embodiments, the processor 416 may be positioned within the charging station 100, or within a robot being used with the charging station 100. The cloud connect system 400 may be adapted to store a list of registered charging stations 404. A user may manually register charging stations 100 with the cloud connect system 400, or this process may be done automatically when the charging station 100 is connected to the cloud connect system 400. The cloud connect system 400 may be adapted to store an internal environmental map 402, which can store and display a physical map of the locations of all registered charging stations 100. The locations may be stored in the internal environmental map 402 by a number of means, including the use of a coordinate grid or similar location representation mechanism that is well-known in the art. The internal environmental map 402 may be further adapted to receive and store data on the physical layout of the surrounding environment in which one or more charging stations 100 are placed. The cloud connect system 400 may use pathfinding algorithms to direct a robot to a nearby charging station 100, or may use pathfinding or other algorithms to determine other decisions regarding when to begin and end the charging process for each charging station 100. In some embodiments, the cloud connect system 400 may further comprise a list of tasks 406. Each task in the list of tasks 406 may include a task priority 406 and task location. The task priority 406 and task location 412 may be used in determining when to instruct a charging station 100 to finish the charging process. In some embodiments, a user may interact with the cloud connect system 400 using a client device 420. The client device 420 may comprise any computer, mobile device, or similar device capable of implementing and running a software application and capable of wireless or wired communication that is well-known in the art. In some embodiments, the charging station 100 may use a many-to-one topology based on wi-fi media access control (MAC) addresses to identify charging stations 100. The cloud connect system 400 may send a robot the list of MAC addresses for use in calling and navigating to the correct charging station 100.

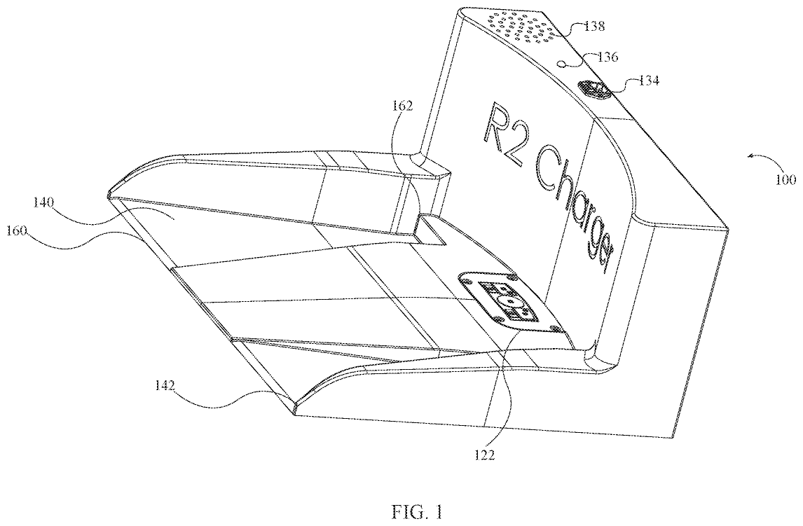

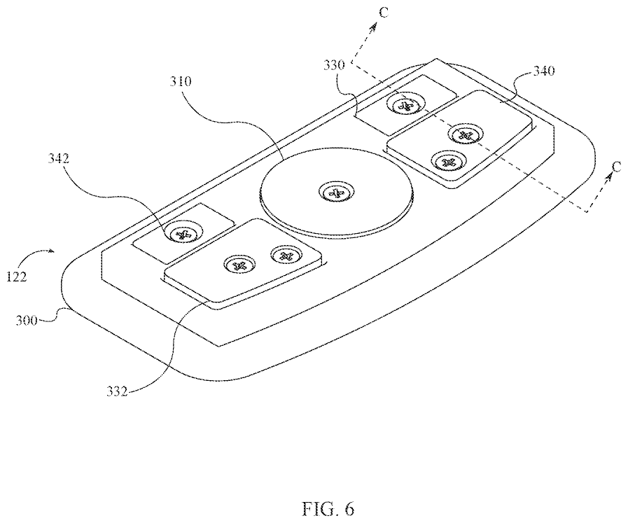

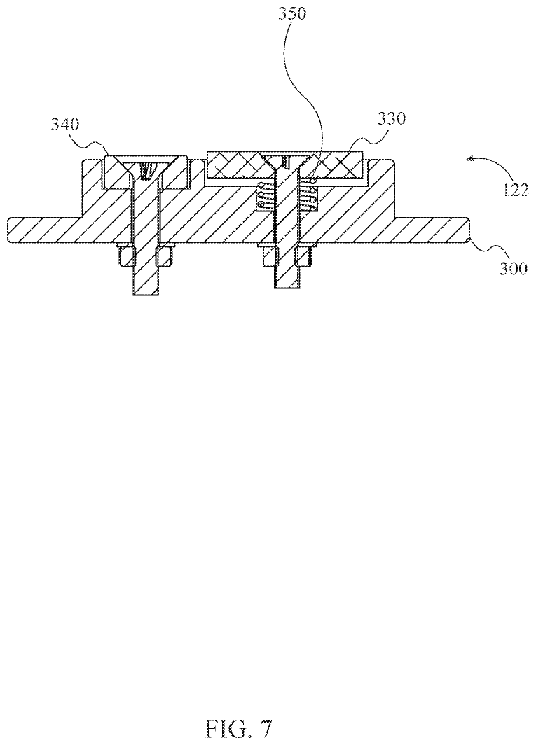

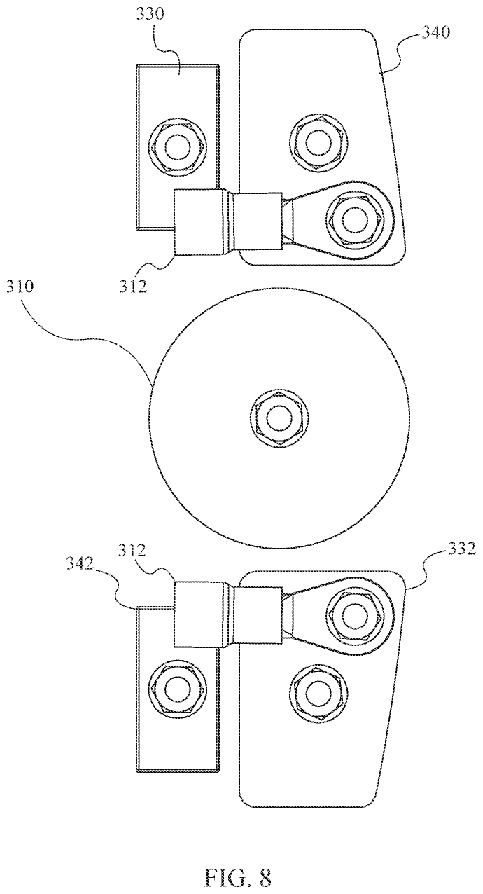

Referring now to FIGS. 1-9, the charging station 100 is ideally made from a plastic material, though other materials are within the spirit and scope of the present invention. In the ideal embodiment, the power outlet 134 may be positioned on the top of the charging station 100, and the power outlet 134 may be adapted to receive power in any means well-known in the art, such as by connection to a wall outlet through a plug. The indicator light 136 may be a colored LED light or other illumination device well-known in the art, and is ideally positioned near the power outlet 134, and is adapted to connect to the electrical circuit 102. The indicator light 136 is adapted to change color based on the measured charge of a currently connected robot. For example, the indicator light 136 may turn red if the charge is low, may turn yellow if the charge is medium, or may turn green if the charge is high. Charge may be determined either by measuring the resistance of the electrical circuit 102, or may be received as a numerical value from a measurement derived from the cloud connect system 400.

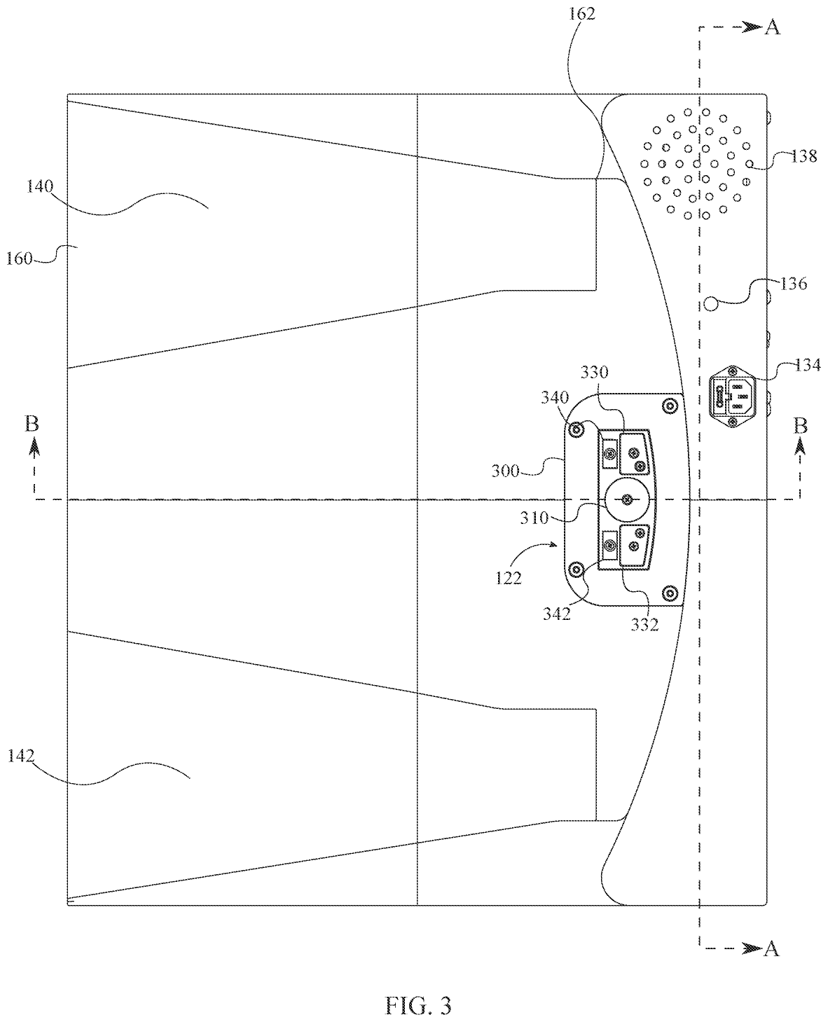

Referring now to FIG. 1 and FIG. 3, the charging station 100 may further comprise a tread receiver. The tread receiver is designed to accept the tread of a robot and guide the robot into a charging position. To that end, the tread receiver comprises a tread opening 160 and an end cap 162. The tread opening 160 may comprise an opening in the front of the tread receiver through which the wheels or treads of a robot can pass. The end cap 162 may comprise a raised portion designed to stop a robot once the robot has reached the end of the tread receiver. In the ideal embodiment, as seen in FIG. 1, the tread receiver is wider at the tread opening 160 and narrower at the end cap 162. This configuration slowly guides the robot into the proper position and orientation for proper charging while allowing a margin of error on the precise entry into the tread receiver. In the ideal embodiment, the charging station 100 is adapted to receive a robot with two wheels, and thus comprises a first tread receiver 140 and a second tread receiver 142. However, any number of tread receivers is within the spirit and scope of the present invention.

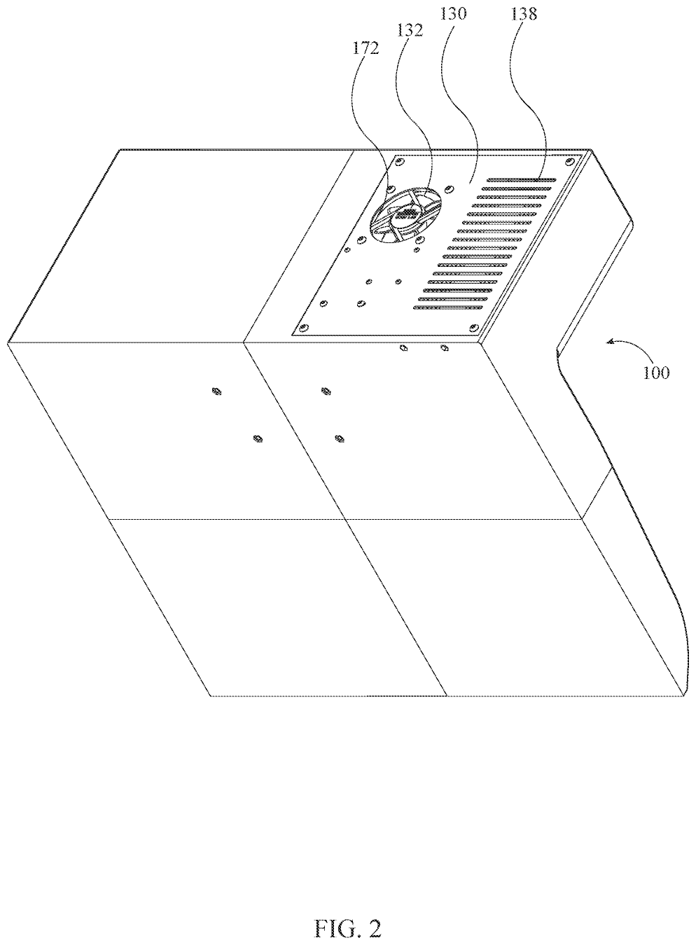

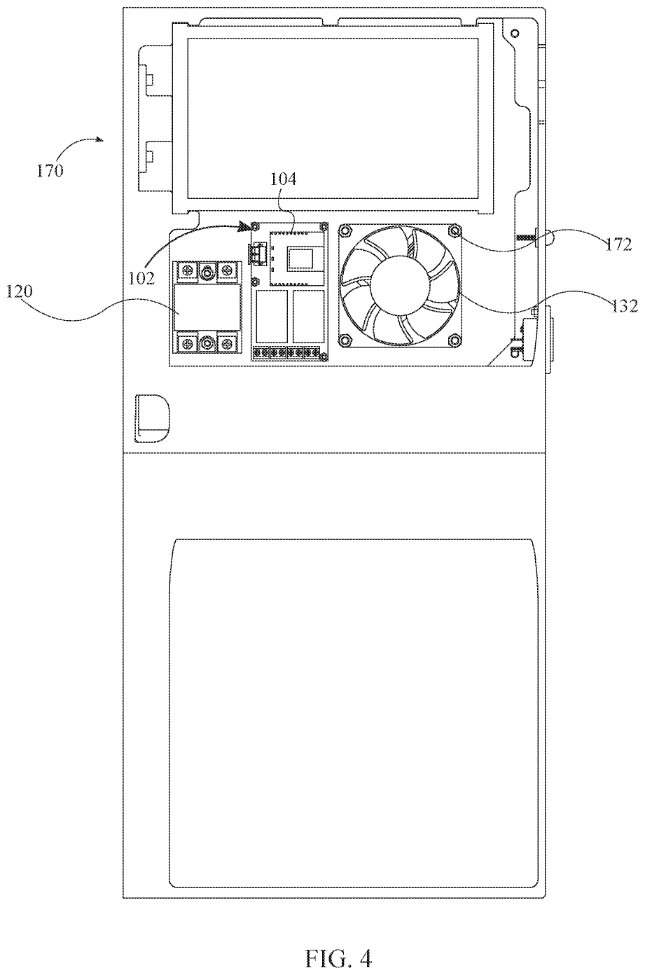

Referring now to FIG. 2 and FIG. 4, in the ideal embodiment, the rear access panel 130 may be detachably attachable from the rear of the charging station 100. In the ideal embodiment, the rear access panel 130 may further comprise a plurality of ventilation holes 138 to allow for proper circulation into the interior compartment 170 of the charging station 100. In some embodiments, some of the plurality of ventilation holes 138 may be positioned on top of the charging station 100. When removed, the rear access panel 130 may expose the interior compartment 170 of the charging station 100. In this embodiment, the rear access panel 130 would be attached to an opening of the interior compartment 170. In the ideal embodiment, the interior compartment 170 acts as a housing for the electrical components of the charging station 100. For example, the power supply 124, electrical circuit 102, voltage control board 104, power transformer, and wireless connector 120 may be positioned within the interior compartment 170 of the charging station 100. In some embodiments, the rear access panel 130 may further comprise a fan attachment slot 172. The fan attachment slot 172 may be adapted to receive the fan 132, such as by providing fastening points to which the fan 132 can be fastened. The fan 132 is adapted to rotate to move air through the interior compartment 170 and out the ventilation holes, creating a cooling action to ensure the components in the interior compartment 170 do not overheat.

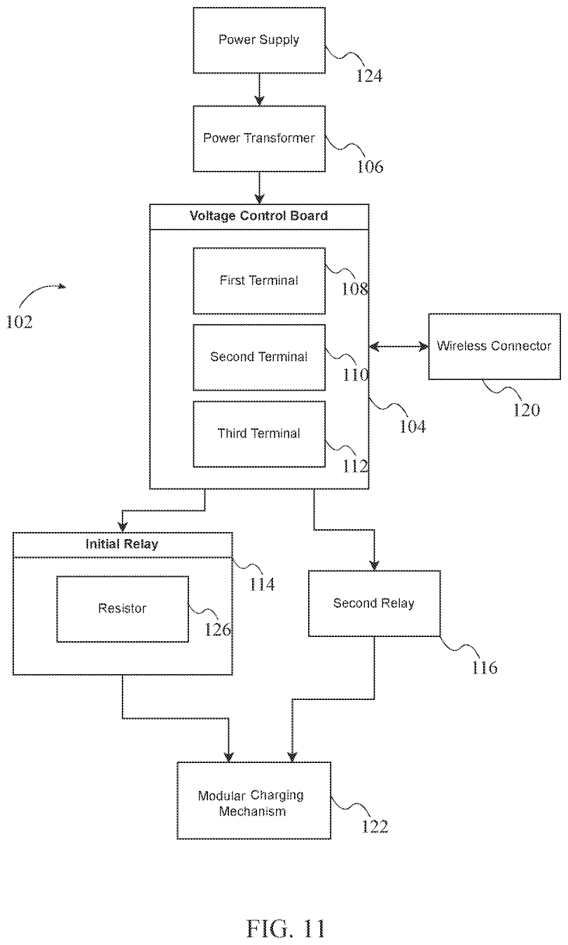

Referring now to FIG. 11, the electrical circuit 102 is adapted to manage voltages and connect the constituent electrical components as is well-known in the art. An exemplary embodiment of the electrical circuit 102 is described herein, though it should be understood that other embodiments of electrical circuits that accomplish similar functions of providing, transforming, and managing electrical and power output are within the spirit and scope of the present invention. The electrical circuit 102 may comprise the voltage control board 104, the power transformer 106, the terminal, the electrical relay, the wireless connector 120, and the at least one modular charging mechanism 122. In the ideal embodiment, the voltage control board 104 is modeled after an ESP32-S3 board, and may further be coupled to the wireless connector 120 to receive commands from the cloud connect software or a robot using the charging station 100.

The voltage control board 104 may comprise an electrical terminal. In the ideal embodiment, the electrical terminal may comprise a first terminal 108, a second terminal 110, and a third terminal 112. The charging station 100 may further comprise a stage-based relay. The stage-based relay may further comprise an initial relay 114 and a second relay 116. In the ideal embodiment, the initial relay 114 further comprises a resistor 126. When the charging process begins, the initial relay 114 is designed to engage before the second relay 116 to minimize the initial starting current and prevent electrical arcs. Once the charging process has begun, the second relay 116 enables the charging current (ideally being 10 A) to begin flowing into the contacts. The power supply 124 may comprise the power outlet 134 receiving power from an external source, described above, or may comprise a rechargeable battery or similar power source that is well-known in the art. The power transformer 106 may be an AC/DC transformer operating at 3.3V.

The modular charging mechanism 122 may further comprise a charging housing 300, a contact charging plate, a rare earth magnet, a plate spring, and a central metal plate 310.

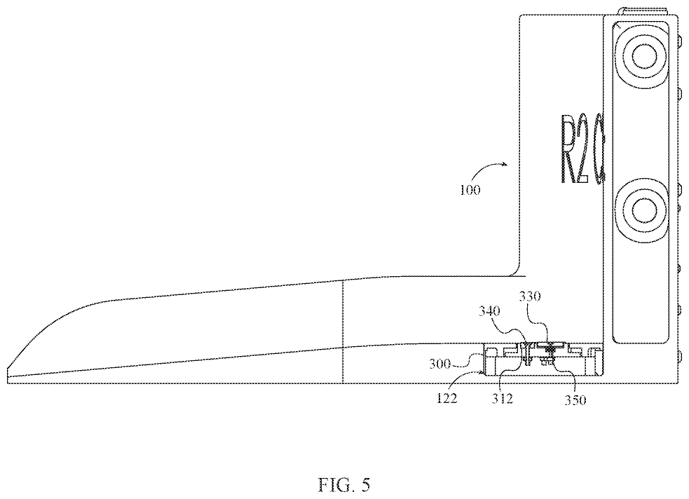

Referring now to FIG. 1, FIG. 3, and FIGS. 5-8, the charging housing 300 may comprise a body that is roughly rectangular in shape, though any shape or configuration are within the spirit and scope of the invention. The body may further comprise openings to accept the rare earth magnet, contact charging plate, rare earth magnet, plate spring, power terminal connection 312, and central metal plate 310.

The contact charging plate is ideally made from aluminum, though any other metal capable of transmitting electrical charge is contemplated. The contact charging plate is positioned above a plate spring, and is electrically connected to the power terminal connection 312. The power terminal connection 312 is in turn electrically connected to the electrical circuit 102, allowing electrical charge to flow from the electrical circuit 102 and into the contact charging plate. This configuration allows charge to be transmitted through the contact charging plate and into an adjacent robot when an associated charging plate on the robot is in contact with the contact charging plate. The plate spring may be positioned in a divot or hollow beneath the contact charging plate. The plate spring is adapted to allow the contact charging plate to slightly depress and shift when pressure is applied. This configuration allows smooth contact surfaces between the contact charging plate and an associated charging plate of a robot. As many robots are quite large, and may contain 40 A batteries, for example, proper contact is needed to charge properly. Even slight misalignment may produce electrical arcs and burn the contact plates. Thus, if the contact charging plate is biased by the plate spring, the plate spring can help keep the charging contact surface level and avoid any arcs, burns, or other hazards during the charging process. In the ideal embodiment, the charging station 100 may comprise a first contact charging plate 300 and a second contact charging plate 332. The first contact charging plate 300 is supported by a first plate spring 350, and the second contact charging plate 332 is supported by a second plate spring 352.

The rare earth magnet is positioned on the charging housing 300, ideally in proximity to the contact charging plate. The rare earth magnet may comprise any magnetic substance well-known in the art. The rare earth magnet may be adapted to connect to an associated metal plate on the robot being charged. This configuration assists in pulling the robot into the proper position for charging, as the rare earth magnet will bias the robot into the proper position to be in complete contact with the contact charging plate. In the ideal embodiment, the charging station 100 may comprise a first rare earth magnet 340 and a second rare earth magnet 342, though other numbers or configurations of the rare earth magnet are within the spirit and scope of the present invention.

The central metal plate 310 is ideally made from a magnetic metal. The central metal plate 310 is adapted to be in proximity to the contact charging plate. The central metal plate 310 is ideally positioned central to the charging housing 300, and is configured to connect to a magnet positioned on a robot to be charged, assisting in aligning the robot properly with the charging station 100 and the contact charging plate.

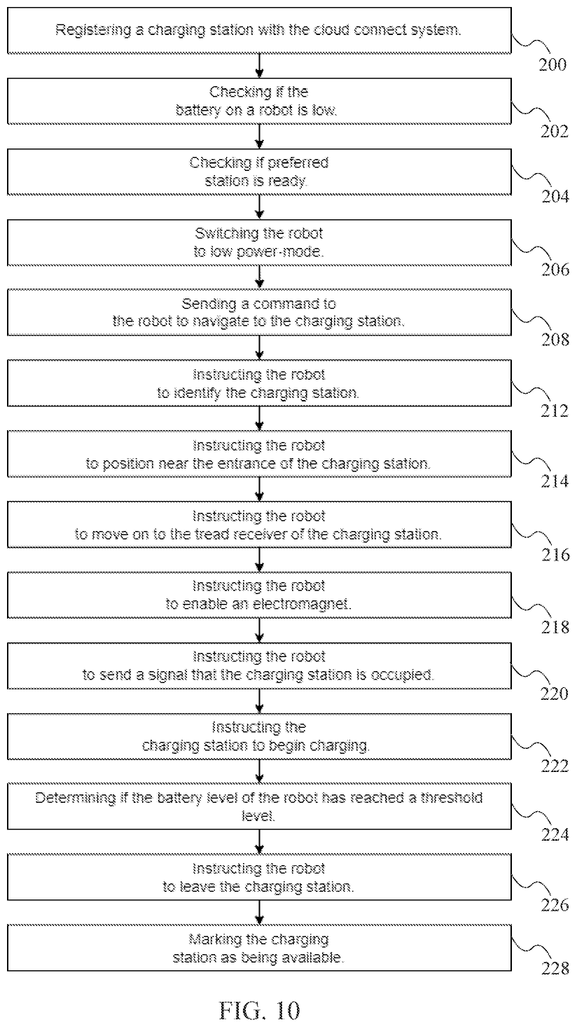

Turning now to the method of use of the charging station 100 and related cloud connect system 400, FIG. 10 shows a flowchart of the method of use. The method of use may comprise the following steps set forth below. It should be understood that steps may be removed or reordered within the scope of the present invention:
a) Registering a charging station 100 with the cloud connect system 200.
b) Checking if the battery on a robot is low 202.
c) Checking if a preferred station is ready 204.
d) Switching the robot to a low-power mode 206.
e) Sending a command to the robot to navigate to the charging station 100 208.
f) Instructing the robot to identify the charging station 100 212.
g) Instructing the robot to position near the entrance of the charging station 100 214.
h) Instructing the robot to move onto the tread receiver of the charging station 100 216.
i) Instructing the robot to enable an electromagnet 218.
j) Instructing the robot to send a signal that the charging station 100 is occupied 220.
k) Instructing the robot to send a signal to the charging station 100 to begin charging 222.
l) Determining if the battery level of the robot has reached a threshold level 224.
m) Instructing the robot to leave the charging station 100 226.
n) Marking the charging station 100 as being available 228.

First, a user may perform the step of registering a charging station 100 with the cloud connect system 400 200. This step may comprise adding a charging station 100 to the list of registered charging stations 100 404 in the software. This may be done, for example, by manually entering the charging station 100 information using the client device 420, or may be configured so that a charging station 100 manually communicates the charging station 100 information with the cloud connect system 400 using the wireless connector 120 of the charging station 100.

Next, the method comprises checking if the battery on a robot is low 202. The robot may measure its battery charge through any means well-known in the art, such as measuring resistance through an electrical circuit 102. If the battery is high, the robot may continue functioning and repeat this step at a future time. If the battery is low, the next step of the method may be performed.

Next, the method may comprise the step of checking if a preferred station is ready 204. A ready station may comprise a station that is both unoccupied and connected to power, connected to the cloud connect system 400, or both. The status of the charging station 100 may be communicated to the robot by the cloud connect system 400, or the charging station 100 itself may keep track of the charging station 100 using the wireless connector 120 and the electronic circuit, the charging station 100 then communicating the status directly to the robot using the wireless connector 120.

Next, the method may comprise the step of switching the robot to low power mode 206. Switching the robot to a low power mode may comprise turning off any systems non-essential for navigation and propulsion. For example, a cleaning robot may be instructed to turn off any associated cleaning device while leaving the motor, wheels, and wireless communicator powered.

Next, the method comprises the step of sending a command to the robot to navigate to the charging station 100 210. The command may be sent using the cloud connect system 400, or the robot may possess internal logic and a processing unit to issue the instruction to itself. The robot may ideally be provided with navigation information using the internal environmental map 402 of the cloud connect system 400, and may be provided with navigation data or a route that is processed using any pathfinding algorithm that is well-known in the art. In some embodiments, the cloud connect system 400 may send a known or defined MAC address of the charging station 100 from the cloud connect system 400 to identify the charging station 100 for the robot.

Next, the method may comprise the step of instructing the robot to identify the charging station 100 212. In the ideal embodiment, this step comprises using onboard identification devices on the robot to identify the charging station 100, such as a stereo camera and AI software to identify the physical location and appearance of the charging station 100. In other embodiments, the charging station 100 may be identified by other means, such as by verifying the MAC address or using other digital or physical identifiers.

Next, the method may comprise the step of instructing the robot to position near the entrance of the charging station 100 214. The robot may position itself using the internal environmental map 402 of the cloud connect software, or may position itself using onboard navigation mechanisms as are well-known in the art, such as cameras to identify the spacing and location.

Next, the method may comprise the step of instructing the robot to move on to the tread receiver of the charging station 100 216. The robot is instructed to move forward slowly until the magnetic field from the rare earth magnet of the charging station 100 is detected using a hall effect sensor on the robot.

Once the hall effect sensor of the robot has detected a magnetic field, the method may comprise the step of instructing the robot to enable an electromagnet 218. The electromagnet of the robot may be adapted to connect to the central metal plate 310 of the modular charging mechanism 122 of the charging station 100, helping align the robot to the charging area and fastening the robot to the charging station 100.

Next, the method may comprise the step of instructing the robot to send a signal that the charging station 100 is occupied 220. This may be accomplished by the robot directly communicating with the cloud connect software using the wireless communication mechanism 418 of the cloud connect software, or a message may be sent directly to the wireless connector 120 of the charging station 100 to instruct the charging station 100 to flag itself as occupied.

Next, the method may comprise the step of instructing the charging station 100 to begin charging 222. The charging station 100 may either receive an instruction from the robot itself, or may receive the instruction from the cloud connect software. Once the instruction is received, the charging station 100 may power the contact charging plate as is described above in this document, using the electrical circuit 102, and beginning the charge with the initial relay 114 before activating the second relay 116. In this embodiment, when the charging station 100 receives an instruction to begin charging, the initial relay 114 is adapted to activate before the second relay 116.

Next, the method may comprise the step of determining if the battery level of the robot has reached a threshold level 224. The threshold level may be determined using the list of tasks 406 of the cloud connect system 400. For example, the threshold level may be calculated by combining the task location 412 and task priority 406 of each task in the list of tasks 406 to determine the threshold level based on the number of tasks to be completed on the next trip from the robot, though other means of determining the threshold level are within the spirit and scope of the present invention. The current battery level of the robot may be monitored by the robot itself, or may be monitored by the charging station 100, for example, by measuring the resistance in the electrical charging circuit, or by using another means of battery level monitoring well known in the art. In some embodiments, the battery level may be communicated to and managed by the cloud connect system 400. In other embodiments, the robot or charging station 100 may be responsible for measuring the battery level. If the battery has reached the threshold level, the robot may be instructed to stop charging and leave the charging station 100. If the battery has not reached the threshold level, the robot may remain in a charging state.

Next, the method may comprise the step of instructing the robot to leave the charging station 100 226. If the threshold level has been reached, the robot may be instructed to leave the charging station 100, either by receiving a command from the cloud connect system 400, or by receiving an instruction from the charging station 100. Once the instruction is received, the robot may turn off the electromagnet to release the connection to the charging station 100, and may reverse out of the tread receiver of the charging station 100.

Next, the method may comprise the step of marking the charging station 100 as being available 228. Once the robot has released the electromagnet and ceased charging, the charging station 100 may be marked as available. This may be done using the cloud connect system 400 to mark the charging station 100 as available in the list of charging stations 100, or the charging station 100 may issue an indication directly using the wireless connector 120.

Once the charging station 100 is available, the process may be repeated from the step of checking if the battery on a robot is low 202. Though a method of use of the charging station 100 has been described above, it should be understood that alterations in the steps, order of the steps, and exact details of the steps can be performed and remain within the spirit and scope of the present invention.

Although the invention has been explained in relation to its preferred embodiment, it is to be understood that many other possible modifications and variations can be made without departing from the spirit and scope of the invention.

I claim:

1. A charging station comprising:
a power supply;
an electrical circuit;
the power supply being electrically connected to the electrical circuit;
at least one tread receiver;
the at least one tread receiver comprising a tread opening and an end cap;
at least one modular charging mechanism;
a power outlet;
the at least one modular charging plate comprising a charging housing, a contact charging plate, at least one rare earth magnet, at least one plate spring, at least one metal base plate, at least one power terminal connection and a central metal plate;
the at least one power terminal connection being electrically connected to the at least one contact charging plate; and
the at least one power terminal connection being electrically connected to the electrical circuit.

2. The charging station of claim 1, further comprising:
the electrical circuit comprising: a voltage control board, a power transformer, at least one terminal, at least one stage-based relay, and a wireless connector.

3. The charging station of claim 2, further comprising:
the at least one terminal comprising a first terminal, a second terminal, and a third terminal; and
the at least one stage-based relay comprising an initial relay, a second relay, and a third relay.

4. The charging station of claim 3, further comprising:
the initial relay further comprising a resistor; and
wherein the initial relay is adapted to activate before the second relay.

5. The charging station of claim 1, further comprising:
wherein the at least one plate spring is positioned beneath the at least one metal base plate.

6. The charging station of claim 1, further comprising:
the at least one contact charging plate comprising a first contact charging plate and a second contact charging plate.

7. The charging station of claim 6, further comprising:
the at least one rare earth magnet comprising a first rare earth magnet and a second rare earth magnet.

8. The charging station of claim 7, further comprising:
the at least one plate spring comprising a first plate spring and a second plate spring.

9. The charging station of claim 5, further comprising:
wherein the at least one metal base plate is comprised of aluminum.

10. The charging station of claim 1, further comprising:
an interior compartment.

11. The charging station of claim 10, further comprising:
a rear access panel;
the rear access panel being positioned to cover an opening of the interior compartment; and
wherein the rear access panel is detachably attachable to the charging station.

12. The charging station of claim 11, further comprising:
a fan;
wherein the fan is detachably attachable to the rear access panel;
a plurality of ventilation holes; and
wherein the plurality of ventilation holes is positioned both on the top of the charging station and on the rear access panel.

13. The charging station of claim 1, further comprising:
a cloud connect system;
wherein the cloud connect system further comprises an internal environmental map, a list of registered charging stations, a list of tasks, a database, a processor, and a wireless communication mechanism; and
each task in the list of task being associated with a task priority and a task location.

14. The charging station of claim 1, further comprising:
the tread opening being wider than the end cap;
the at least one tread receiver comprising a first tread receiver and a second tread receiver.

15. The charging station of claim 1, further comprising:
the power outlet being positioned on top of the charging station;
an indicator light; and
the indicator light being adapted to display a first color, a second color, and a third color.

16. A charging station comprising:
a power supply;
an electrical circuit;
the power supply being electrically connected to the electrical circuit;
the electrical circuit comprising: a voltage control board, a power transformer, at least one terminal, at least one stage-based relay, and a wireless connector;
an interior compartment;
a cloud connect system;
at least one tread receiver;
the at least one tread receiver comprising a tread opening and an end cap;
the tread opening being wider than the end cap;
at least one modular charging mechanism;
the at least one modular charging plate comprising a charging housing, a contact charging plate, at least one rare earth magnet, at least one plate spring, at least one metal base plate, at least one power terminal connection and a central metal plate;
the at least one power terminal connection being electrically connected to the at least one contact charging plate;
the at least one power terminal connection being electrically connected to the electrical circuit;
wherein the at least one plate spring is positioned beneath the at least one metal base plate;
a rear access panel;
the rear access panel being positioned to cover an opening of the interior compartment;
wherein the rear access panel is detachably attachable to the charging station;
a fan;
wherein the fan is detachably attachable to the rear access panel;
a plurality of ventilation holes;
wherein the plurality of ventilation holes is positioned both on the top of the charging station and on the rear access panel;
a power outlet;
the power outlet being positioned on the top of the charging station;
wherein the cloud connect system further comprises an internal environmental map, a list of registered charging stations, a list of tasks, a database, a processor, and a wireless communication mechanism;
each task in the list of task being associated with a task priority and a task location;
an indicator light; and
the indicator light being adapted to display a first color, a second color, and a third color.

17. The charging station of claim 16, further comprising:
the at least one terminal comprising a first terminal, a second terminal, and a third terminal;
the at least one stage-based relay comprising an initial relay, a second relay, and a third relay;
the initial relay further comprising a resistor;
wherein the initial relay is adapted to activate before the second relay;
the at least one tread receiver comprising a first tread receiver and a second tread receiver;
the at least one contact charging plate comprising a first contact charging plate and a second contact charging plate;
the at least one rare earth magnet comprising a first rare earth magnet and a second rare earth magnet;
the at least one plate spring comprising a first plate spring and a second plate spring;
the at least one metal base plate comprising a first metal base plate and a second metal base plate; and
wherein the at least one metal base plate is comprised of aluminum.

18. A method of using a charging station, the method comprising:
registering a charging station with a cloud connect system;
wherein the cloud connect system comprises an internal environmental map, a list of registered charging stations, a list of tasks, a database, a processor, and a wireless communication mechanism;
checking if the battery on a robot is low;
sending a command to the robot to navigate to the charging station;
instructing the robot to identify the charging station;
instructing the robot to position near the entrance of the charging station;
instructing the robot to move onto a tread receiver of the charging station;
instructing the robot to enable an electromagnet;
instructing the charging station to begin charging;
monitoring the battery level of the robot;
instructing the robot to leave from the charging station; and
marking the charging station as being available in the list of registered charging stations.

19. The method of claim 18, further comprising:
checking if a charging station is ready, wherein the ready status is indicated when the charging station is unoccupied and connected;
switching the robot to a low power mode; and
instructing the robot to send a signal to the cloud connect system to indicate that the charging station is occupied.

20. The method of claim 19, further comprising:
determining if the battery level of the robot has reached a threshold level; and
wherein the threshold level is determined based on a task priority and task location associated with each task in the list of tasks of the cloud connect system.
